(19) United States
(12) Patent Application Publication
(10) Pub. No.: US 2025/0123764 A1
(43) Pub. Date: Apr. 17, 2025

(54) STORAGE DEVICE FOR MANAGING SUPER BLOCK AND METHOD OF OPERATING THE SAME

(71) Applicant: SK hynix Inc., Gyeonggi-do (KR)

(72) Inventors: Seon Ju LEE, Gyeonggi-do (KR); Jeong Sun PARK, Gyeonggi-do (KR)

(21) Appl. No.: 18/611,737

(22) Filed: Mar. 21, 2024

(30) Foreign Application Priority Data
Oct. 11, 2023 (KR) 10-2023-0135117

(51) Int. Cl. G06F 3/06

(52) U.S. Cl. CPC G06F 3/064; G06F 3/0604; G06F 3/0655; G06F 3/0679

(57) ABSTRACT

Provided herein is a semiconductor memory device having improved lifespan. The storage device may include a memory device including a plurality of super blocks, and a controller configured to control the memory device in response to each request among a plurality of requests from a host, wherein the controller is further configured to allocate a first super block to a first write request of a first type, and allocate a second super block different from the first super block to respond to a second write request of a second type, control the memory device to store in the first super block write data corresponding to the first write request, and when the second write request is received from the host before reallocation of the second super block after deallocation, control the memory device to store in the first super block write data corresponding to the second write request.

### CROSS-REFERENCE TO RELATED APPLICATION

The present application claims priority under 35 U.S.C. § 119(a) to Korean patent application number 10-2023-0135117 filed on Oct. 11, 2023, the entire disclosure of which is incorporated by reference herein.

### BACKGROUND

### 1. Field of Invention

Various embodiments of the present disclosure generally relate to a semiconductor device, and more particularly to a storage device for managing a super block and a method of operating the storage device.

### 2. Description of Related Art

A storage device is a device which stores data under the control of a host, such as a computer or a smartphone. The storage device may include a memory device in which data is stored and a controller which controls the memory device. The memory device may include a plurality of dies coupled to a plurality of channels, and each die may include a plurality of memory blocks.

The storage device may manage a plurality of memory blocks on a super block basis. Each super block may be composed of a plurality of memory blocks, and a write operation may be performed on a super block basis. Here, for respective types of write requests from the host, separate super blocks may be allocated. For example, the storage device may allocate a super block corresponding to a sequential write request and/or a super block corresponding to a random write request.

When the sequential write request and the random write request are simultaneously received in the state in which super blocks for respective types are allocated, the operational performance of the storage device may be improved. However, when only one of the sequential write request and the random write request is continuously received for a certain period, a super block corresponding to the other may not be used for the certain period. In this case, the availability of over-provisioning related to the lifespan of the storage device may be deteriorated.

### SUMMARY

Various embodiments of the present disclosure are directed to a storage device having improved lifespan and a method of operating the storage device.

An embodiment of the present disclosure may provide for a storage device. The storage device may include a memory device including a plurality of super blocks, each including a plurality of memory blocks, and a controller configured to control the memory device in response to each request among a plurality of requests from a host, wherein the controller is further configured to allocate a first super block among the plurality of super blocks to a first write request among the plurality of requests from the host, and allocate a second super block among the plurality of super blocks to a second write request among the plurality of requests from the host, the second super block being different from the first super block, the first write request being a request of a first type, the second write request being a request of a second type different from the first type, control the memory device to store in the first super block write data corresponding to the first write request, deallocating at least one of the first super block and the second super block, and when the second write request is received from the host before the second super block is reallocated after the deallocation of the second super block, control the memory device to store in the first super block write data corresponding to the second write request.

An embodiment of the present disclosure may provide for a storage device. The storage device may include a memory device including a plurality of super blocks, each including a plurality of memory blocks, and a controller configured to control the memory device in response to each request among a plurality of requests from a host, wherein the controller is further configured to allocate a first super block among the plurality of super blocks in response to a first write request among the plurality of requests from the host, the first write request being a request of a first type, allocate a second super block among the plurality of super blocks in response to a second write request among the plurality of requests from the host, the second write request being a request of a second type different from the first type, count, as a first count, a number of times the first write request is received from the host and count, as a second count, a number of times the second write request is received from the host, and deallocate the first super block or the second super block based on the first count and the second count.

An embodiment of the present disclosure may provide for a method of operating a storage device. The method may include allocating storage regions to write requests of different types among requests from a host, monitoring, as a first count, a number of times a write request of a first type among the writes requests is received from the host, and, as a second count, a number of times a write request of a second type is received from the host, the second type being different from the first type, deallocating one of storage regions respectively corresponding to the write request of the first type and the write request of the second type, based on the first count and the second count, receiving, from the host, the write request of the first type, determining whether a deallocated storage region corresponds to the write request of the first type, and storing write data corresponding to the received write request of the first type in one of the storage regions respectively corresponding to the write request of the first type and the write request of the second type based on a result of the determination.

Other features, aspects, and advantages of the embodiments of the present disclosure will become apparent from the following detailed description, the drawings, and the claims.

### BRIEF DESCRIPTION OF THE DRAWINGS

FIG. 1 is a diagram illustrating a storage device according to an embodiment of the present disclosure.

FIG. 2 is a diagram illustrating a super block manager according to an embodiment of the present disclosure.

FIG. 3 is a diagram illustrating a write operation performed on a super block according to an embodiment of the present disclosure.

FIG. 4 is a diagram illustrating a write operation performed on a super block according to an embodiment of the present disclosure.

FIG. 5 is a diagram illustrating a super block deallocated according to an embodiment of the present disclosure.

FIG. 6 is a flowchart illustrating a method of operating a storage device according to an embodiment of the present disclosure.

FIG. 7 is a flowchart illustrating a method of deallocating a super block according to an embodiment of the present disclosure.

FIG. 8 is a flowchart illustrating a method of storing write data in a super block according to an embodiment of the present disclosure.

FIG. 9 is a diagram illustrating a controller according to an embodiment of the present disclosure.

### DETAILED DESCRIPTION

Specific structural or functional descriptions in the embodiments of the present disclosure introduced in this specification are provided as examples to describe embodiments according to the concept of the present disclosure. The embodiments according to the concept of the present disclosure may be practiced in various forms, and should not be construed as being limited to the embodiments described in the specification or application.

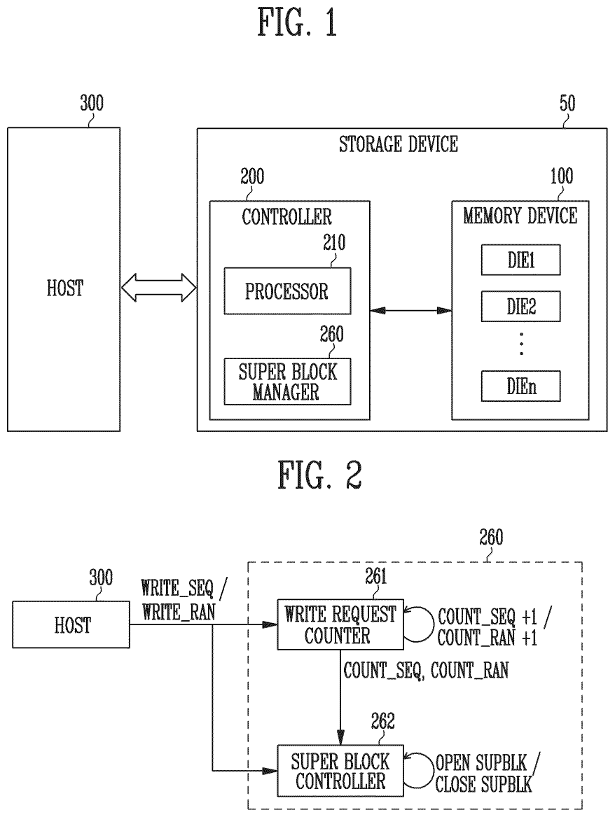

FIG. 1 is a diagram illustrating a storage device 50 according to an embodiment of the present disclosure.

Referring to FIG. 1, the storage device 50 may include a memory device 100 and a controller 200 which controls the operation of the memory device 100. The storage device 50 may store data under the control of a host 300, such as a mobile phone, a smartphone, an MP3 player, a laptop computer, a desktop computer, a game console, a television (TV), a tablet PC, or an in-vehicle infotainment system.

The storage device 50 may be manufactured as one of various types of storage devices depending on a host interface that is a scheme for communication with the host 300. The storage device 50 may be manufactured in one of various types of package forms. For example, the storage device 50 may be manufactured in one of various types of package forms, such as package on package (POP), system in package (SIP), system on chip (SOC), multi-chip package (MCP), chip on board (COB), wafer-level fabricated package (WFP), and wafer-level stack package (WSP).

The memory device 100 may store data. The memory device 100 may include a plurality of memory cells which store data.

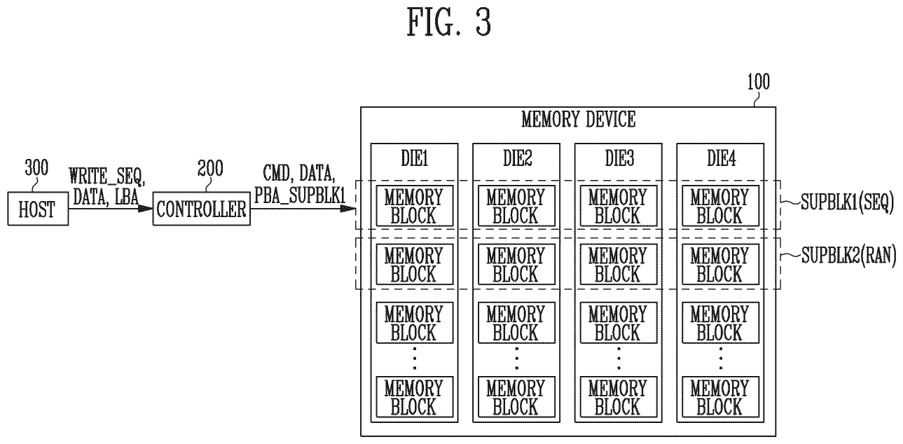

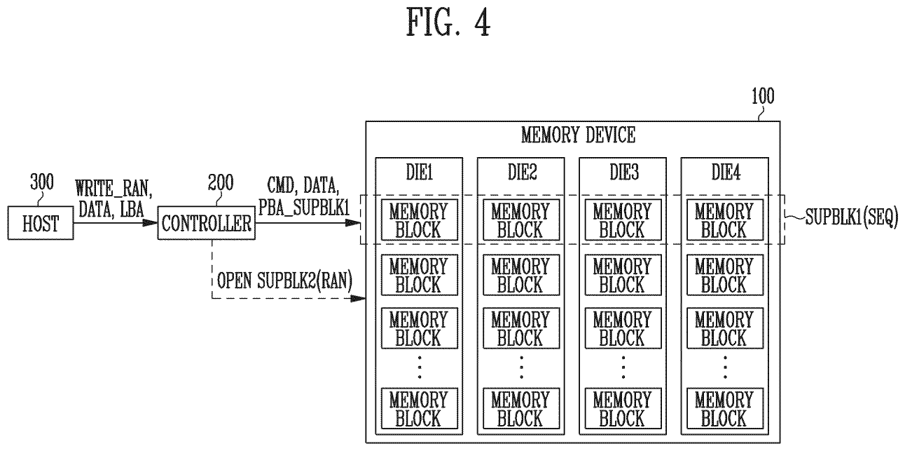

The storage device 100 may include a plurality of dies DIE1 to DIEn. Each of the plurality of dies DIE1 to DIEn may include a plurality of memory blocks. Each memory block may include a plurality of memory cells. In an embodiment, the memory device 100 may be a nonvolatile memory. The plurality of dies DIE1 to DIEn may be coupled to the controller 200 through different channels or one channel. In FIGS. 3, 4, and 5, which will be described later, the number of the dies DIE1 to DIEn is illustrated as four, for convenience of description.

The memory device 100 may receive a command and an address from the controller 200. The memory device 100 may perform an operation indicated by the command on a region selected by the address. For example, the memory device 100 may perform a write operation, a read operation, and an erase operation.

The controller 200 may control the overall operation of the storage device 50.

When power is applied to the storage device 50, the controller 200 may run firmware (FW). When the memory device 100 is a flash memory device, the firmware (FW) may include a host interface layer (HIL) which controls communication with the host 300, a flash translation layer (FTL) which controls communication between the host 300 and the memory device 100, and a flash interface layer (FIL) which controls communication with the memory device 100.

In an embodiment, the controller 200 may receive, from the host 300, data and a logical block address (LBA), and may translate the logical block address (LBA) into a physical block address (PBA) indicating the address of memory cells which are included in the memory device 100 and in which data is to be stored. In the present specification, a logical block address (LBA) and a “logical address” may be used interchangeably with each other. In the present specification, a physical block address (PBA) and a “physical address” may be used interchangeably with each other.

The controller 200 may control the memory device 100 so that a write operation, a read operation or an erase operation is performed in response to a request received from the host 300.

In an embodiment, the controller 200 may independently generate a command, an address, and data regardless of whether a request from the host 300 is received, and may transmit them to the memory device 100. For example, the controller 200 may provide the memory device 100 with commands, addresses, and data which are required for performing read operations and program operations associated with performance of wear leveling, read reclaim, garbage collection, etc.

In an embodiment, the controller 200 may control the plurality of dies DIE1 to DIEn according to an interleaving scheme to improve operational performance. The interleaving scheme may be a scheme for controlling the plurality of dies DIE1 to DIEn so that the operations of at least two of the dies DIE1 to DIEn overlap each other. Unlike the example illustrated in FIG. 1, when a plurality of memory devices are included in the storage device 50, the controller 200 may control the plurality of memory devices according to the interleaving scheme.

In an embodiment, the controller 200 may include a processor 210 and a super block manager 260.

The processor 210 may control the overall operation of the controller 200.

In an embodiment, the processor 210 may execute firmware, code or one or more instructions, which include various types of information required for the operation of the controller 200.

The super block manager 260 may manage super blocks, each including at least two memory blocks. Here, the memory blocks of each super block may be included in different dies or planes.

In an embodiment, the super block manager 260 may manage the super blocks depending on the types of write requests. For example, a write request of a first type may include a sequential write request, and a write request of a second type may include a random write request. The sequential write request may include a write request for consecutive data having sequential addresses. The random write request may include a write request for non-consecutive data having random addresses.

In an embodiment, when power is applied to the storage device 50, the super block manager 260 may allocate a first super block corresponding to the sequential write request and a second super block corresponding to the random write request. Here, the first super block may include a super block for storing sequential write data corresponding to the sequential write request, and the second super block may include a super block for storing random write data corresponding to the random write request.

In an embodiment, when the sequential write request is received from the host 300, the processor 210 may control the memory device 100 to store the sequential write data in one of the first super block and the second super block depending on whether the first super block has been allocated.

When the sequential write request is received from the host 300, the processor 210 may control the memory device 100 to store the sequential write data in one of the first super block and the second super block depending on whether the first super block has been allocated.

The host 300 may communicate with the storage device 50 using at least one of various communication standards or interfaces such as universal serial bus (USB), serial AT attachment (SATA), serial Attached SCSI (SAS), high speed interchip (HSIC), small computer system interface (SCSI), peripheral component interconnection (PCI), PCI express (PCIe), nonvolatile memory express (NVMe), universal flash storage (UFS), secure digital (SD), multimedia card (MMC), embedded MMC (eMMC), dual in-line memory module (DIMM), registered DIMM (RDIMM), and load reduced DIMM (LRDIMM) communication methods.

FIG. 2 is a diagram illustrating a super block manager 260 according to an embodiment of the present disclosure.

Referring to FIG. 2, the super block manager 260 may include a write request counter 261 and a super block controller 262.

The write request counter 261 may count a sequential write request count COUNT_SEQ indicating the number of times a sequential write request WRITE_SEQ is received, and a random write request count COUNT_RAN indicating the number of times a random write request WRITE_RAN is received.

In an example, when the sequential write request WRITE_SEQ is received from the host 300, the write request counter 261 may increase the sequential write request count COUNT_SEQ by a particular value, e.g., one (1). In an example, when the random write request WRITE_RAN is received from the host 300, the write request counter 261 may increase the random write request count COUNT_RAN by a particular value, e.g., (1.

In an embodiment, when one of the sequential write request count COUNT_SEQ and the random write request count COUNT_RAN reaches a reference value, the write request counter 261 may initialize the sequential write request count COUNT_SEQ and the random write request count COUNT_RAN to a particular value, e.g., zero (0).

In an embodiment, the super block controller 262 may allocate a first super block and/or a second super block (i.e., OPEN SUPBLK), or deallocate the first super block and/or the second super block (i.e., CLOSE SUPBLK).

For example, in the case where the first super block has not been

allocated when the sequential write request WRITE_SEQ is received, the storage device 50 may allocate the first super block. Further, in the case where the second super block has not been allocated when the random write request WRITE_RAN is received, the storage device 50 may allocate the second super block.

In an embodiment, the super block manager 260 may deallocate the first super block or the second super block based on the sequential write request count COUNT_SEQ and the random write request count COUNT_RAN. For example, the super block manager 260 may determine one of the first super block and the second super block, which is not used for a certain period, based on the sequential write request count COUNT_SEQ and the random write request count COUNT_RAN, and may deallocate the determined super block.

FIG. 3 is a diagram illustrating a write operation performed on a super block according to an embodiment of the present disclosure.

Referring to FIG. 3, a first super block SUPBLK1 corresponding to a sequential write request WRITE_SEQ and a second super block SUPBLK2 corresponding to a random write request may be allocated. Each of the first super block SUPBLK1 and the second super block SUPBLK2 may include memory blocks included in different dies. Although, in the present specification, memory blocks of the corresponding super block are described as being included in different dies, the present disclosure is not limited thereto. For example, each of a plurality of dies DIE1 to DIE4 may include a plurality of planes, and memory blocks of the corresponding super block may be included in different planes.

The controller 200 may receive, from the host 300, the sequential write request WRITE_SEQ, and sequential write data DATA and a logical block address (LBA) corresponding to the sequential write request WRITE_SEQ.

In an embodiment, the controller 200 may determine whether the first super block SUPBLK1 has been allocated. Because the first super block SUPBLK1 has been allocated, the controller 200 may control the memory device 100 to store the sequential write data DATA in the first super block SUPBLK1. For example, the controller 200 may generate a write command CMD instructing a write operation in response to the sequential write request WRITE_SEQ. Further, the controller 200 may translate the logical block address (LBA) into a physical block address (PBA_SUPBLK1) indicating one of a plurality of memory blocks included in the first super block SUPBLK1. The controller 200 may provide, to the memory device 100, the write command CMD, the sequential write data DATA, and the physical block address (PBA_SUPBLK1).

Although, in FIG. 3, the write operation corresponding to the sequential write request WRITE_SEQ when both the first super block

SUPBLK1 and the second super block SUPBLK2 are allocated, has been described, a write operation corresponding to the random write request may also be equally applied. For example, when a random write request is received from the host 300, the controller 200 may control the memory device 100 to store random write data corresponding to the random write request in the second super block SUPBLK2.

FIG. 4 is a diagram illustrating a write operation performed on a super block according to an embodiment of the present disclosure.

Referring to FIG. 4, a first super block SUPBLK1 corresponding to a sequential write request may be allocated. A second super block SUPBLK2 corresponding to a random write request WRITE_RAN may not yet be allocated.

The controller 200 may receive, from the host 300, the random write request WRITE_RAN, and random write data DATA and a logical block address (LBA) corresponding to the random write request WRITE_RAN.

In an embodiment, the controller 200 may determine whether the second super block SUPBLK2 has been allocated. Because the second super block SUPBLK2 has not been allocated, the controller 200 may control the memory device 100 to store the random write data DATA in the first super block SUPBLK1. For example, the controller 200 may generate a write command CMD instructing a write operation in response to the random write request WRITE_RAN. Further, the controller 200 may translate the logical block address (LBA) into a physical block address (PBA_SUPBLK1) indicating one of a plurality of memory blocks included in the first super block SUPBLK1. The controller 200 may provide, to the memory device 100, the write command CMD, the random write data DATA, and the physical block address (PBA_SUPBLK1).

In an embodiment, the controller 200 may allocate the second super block SUPBLK2 in response to the random write request WRITE_RAN. For example, the controller 200 may allocate a second super block SUPBLK2 including a plurality of memory blocks included in different dies by opening the second super block SUPBLK2. When the random write request WRITE_RAN is received after the second super block SUPBLK2 has been allocated, the controller 200 may control the memory device 100 to store the random write data DATA in the second super block SUPBLK2.

Although, in FIG. 4, a write operation corresponding to the random write request WRITE_RAN when the second super block SUPBLK2 is not yet allocated, has been described, a write operation corresponding to the sequential write request when the first super block SUPBLK1 is not allocated, may also be equally applied. For example, when a sequential write request is received from the host 300 in the state in which the first super block SUPBLK1 is not allocated, the controller 200 may control the memory device 100 to store in the second super block SUPBLK2 sequential write data corresponding to the sequential write request.

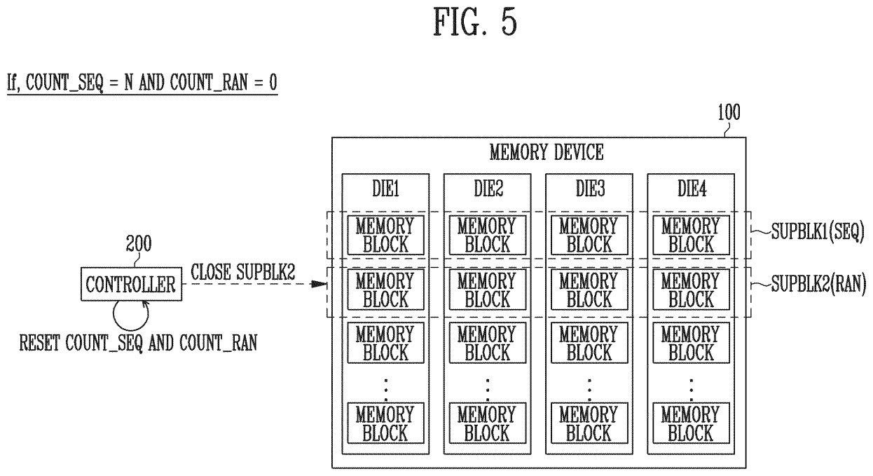

FIG. 5 is a diagram illustrating a super block deallocated according to an embodiment of the present disclosure.

Referring to FIG. 5, a first super block SUPBLK1 corresponding to a sequential write request WRITE_SEQ and a second super block SUPBLK2 corresponding to a random write request WRITE_RAN may be allocated.

In an embodiment, the controller 200 may determine whether a sequential write request count COUNT_SEQ or a random write request count COUNT_RAN has reached a reference value N. For example, after the sequential write request is received from the host 300, the controller 200 may determine whether the sequential write count COUNT_SEQ has reached the reference value N. When the sequential write request count COUNT_SEQ reaches the reference value N, the controller 200 may determine whether the random write request count COUNT_RAN is zero (0) which is an initialization value. When it is determined that the random write request count COUNT_RAN is zero (0), the controller 200 may determine that the second super block SUPBLK2 is not used for a certain period. In this case, the controller 200 may close the second super block SUPBLK2. That is, when the sequential write request count COUNT_SEQ reaches the reference value N and the random write request count COUNT_RAN is zero (0), the controller 200 may deallocate the second super block SUPBLK2.

Furthermore, because the sequential write request count COUNT_SEQ has reached the reference value N, the controller 200 may initialize the sequential write request count COUNT_SEQ and the random write request count COUNT_RAN.

Although, in FIG. 5, an embodiment in which the second super block SUPBLK2 is deallocated is illustrated, the embodiment is not limited thereto, and this embodiment may be equally applied to the case where the first super block SUPBLK1 is deallocated. For example, after a random write request is received from the host 300, the controller 200 may compare the random write request count COUNT_RAN and the sequential write request count COUNT_SEQ with the reference value N and zero (0), respectively. When the random write request count COUNT_RAN reaches the reference value N and the sequential write request count COUNT_SEQ is zero (0), the controller 200 may deallocate the first super block SUPBLK1.

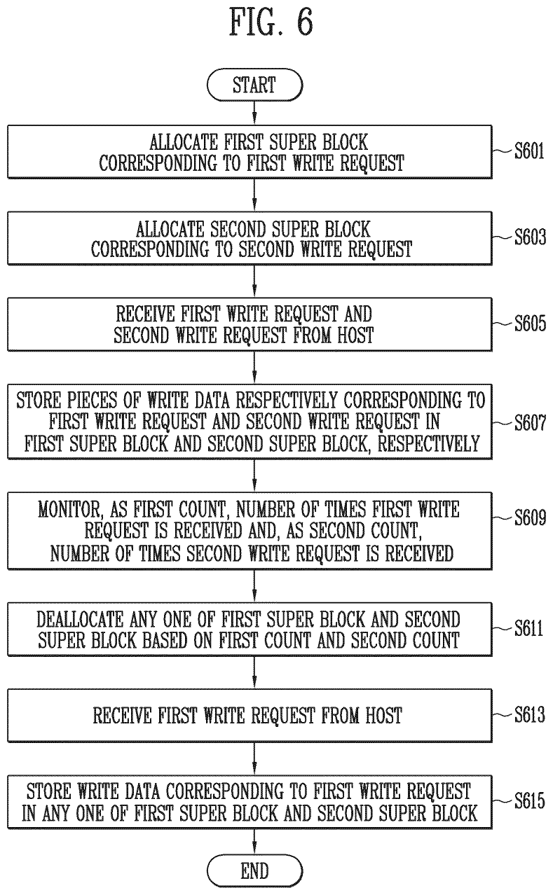

FIG. 6 is a flowchart illustrating a method of operating a storage device according to an embodiment of the present disclosure. The method illustrated in FIG. 6 may be performed by, for example, the storage device 50 illustrated in FIG. 1.

Referring to FIG. 6, at operation S601, the storage device 50 may allocate a first super block corresponding to a first write request of a first type.

At operation S603, the storage device 50 may allocate a second super block corresponding to a second write request of a second type different from the first type. In an embodiment, when the first write request is a sequential write request, the second write request may be a random write request. In another embodiment, when the first write request is a random write request, the second write request may be a sequential write request.

At operation S605, the storage device 50 may receive, from the host 300, the first write request and the second write request.

At operation S607, the storage device 50 may store pieces of write data corresponding to the first write request and the second write request in the first super block and the second super block, respectively.

At operation S609, the storage device 50 may monitor a first count and a second count. The first count may indicate the number of times the first write request is received from the host 300. The second count may indicate the number of times the second write request is received from the host 300. For example, the storage device 50 may increase the first count in response to the reception of the first write request from the host 300. Further, the storage device 50 may increase the second count in response to the reception of the second write request from the host 300. Furthermore, the storage device 50 may initialize the first count and the second count in response to the case where one of the first count and the second count reaches a reference value.

At operation S611, the storage device 50 may deallocate one of the first super block and the second super block based on the first count and the second count.

At operation S613, the storage device 50 may receive the first write request from the host 300.

At operation S615, the storage device 50 may store write data corresponding to the first write request in one of the first super block and the second super block depending on whether the first super block has been allocated.

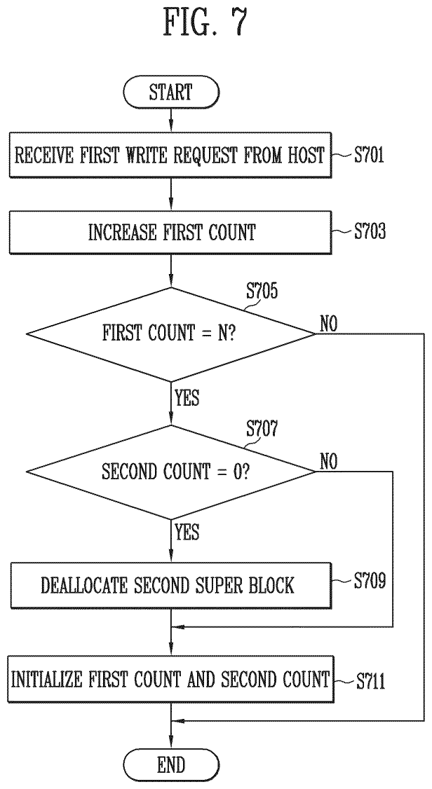

FIG. 7 is a flowchart illustrating a method of deallocating a super block according to an embodiment of the present disclosure. The method illustrated in FIG. 7 may be performed by, for example, the storage device 50 illustrated in FIG. 1. In detail, FIG. 7 is a diagram illustrating the implementation of operations S609 and S611 illustrated in FIG. 6.

Referring to FIG. 7, at operation S701, the storage device 50 may receive a first write request from the host 300.

At operation S703, the storage device 50 may increase a first count.

At operation S705, the storage device 50 may determine whether the first count has reached a reference value N.

When it is determined at operation S705 that the first count has not reached the reference value N (NO), the corresponding operation may be terminated.

When it is determined at operation S705 that the first count has reached the reference value N (YES), the storage device 50 may determine that the second count is zero (0) at operation S707.

When it is determined at operation S707 that the second count is zero (0) (YES), the storage device 50 may deallocate the second super block at operation S709.

At operation S711, the storage device 50 may initialize the first count and the second count. Further, when it is determined at operation S707 that the second count is not zero (0) (NO), the storage device 50 may perform operation S711 without performing operation S709.

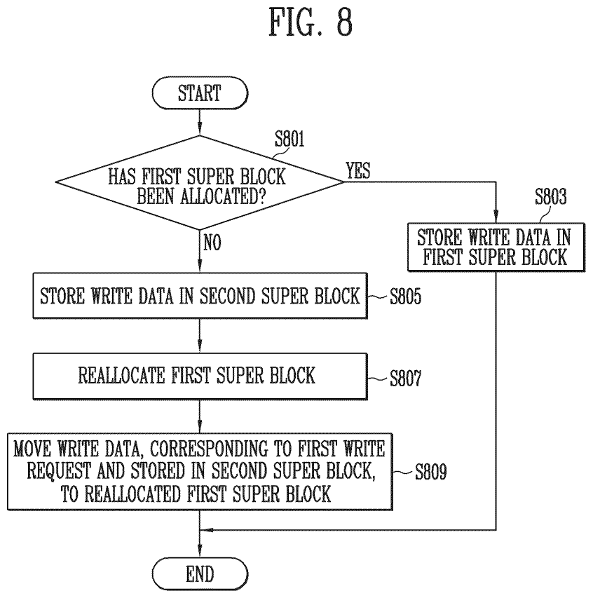

FIG. 8 is a flowchart illustrating a method of storing write data in a super block according to an embodiment of the present disclosure. The method illustrated in FIG. 8 may be performed by, for example, the storage device 50 illustrated in FIG. 1. In detail, FIG. 8 may be a diagram illustrating the implementation of operation S615 illustrated in FIG. 6.

Referring to FIG. 8, at operation S801, the storage device 50 may determine whether a first super block has been allocated.

When it is determined at operation S801 that the first super block has been allocated (YES), the storage device 50 may store write data in the first super block at operation S803.

On the other hand, when it is determined at operation S801 that the first super block has not been allocated (NO), the storage device 50 may store the write data in the second super block at operation S805.

At operation S807, the storage device 50 may reallocate the first super block.

At operation S809, the storage device 50 may move the write data corresponding to the first write request and stored in the second super block, to the first super block. In an embodiment, the storage device 50 may move the write data during a period in which a request from the host 300 is not received.

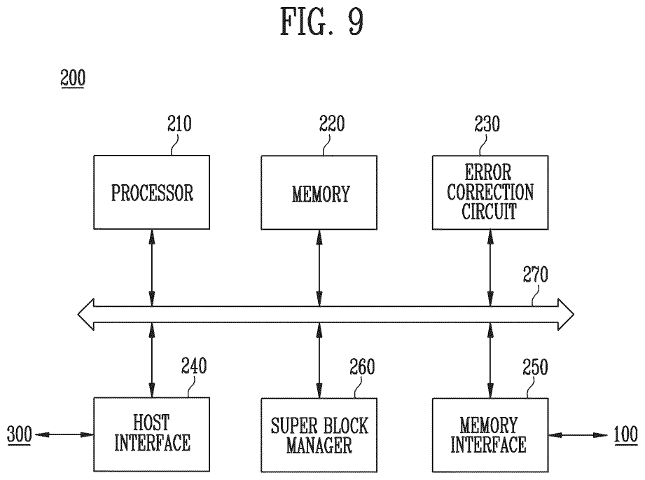

FIG. 9 is a diagram illustrating a controller 200 according to an embodiment of the present disclosure.

Referring to FIG. 9, the controller 200 may include a processor 210, a memory 220, an error correction circuit 230, a host interface 240, a memory interface 250, a super block manager 260, and a communication bus 270. Because the processor 210 and the super block manager 260 of FIG. 9 correspond to the processor 210 and the super block manager 260 of FIG. 1, respectively, a detailed description thereof will be omitted.

The memory 220 may be used as a buffer memory, a cache memory, a working memory, or the like.

Further, the memory 220 may store firmware, code or one or more instructions including various types of information required for the operation of the controller 200.

The error correction circuit 230 may perform error correction. The error correction circuit 230 may perform error correcting code (ECC) encoding based on data to be written to the memory device 100. The encoded data may be transferred to the memory device 100 through the memory interface 250. The error correction circuit 230 may perform ECC decoding on data received from the memory device 100 through the memory interface 250. In an example, the error correction circuit 230 may be included, as the component of the memory interface 250, in the memory interface 250.

The controller 200 may communicate with an external device (e.g., the host 300, an application processor or the like) through the host interface 240.

The controller 200 may communicate with the memory device 100 through the memory interface 250. The controller 200 may transmit to the memory device 100 a command, an address, a control signal, or the like and receive data DATA from the memory device 100, through the memory interface 250.

The processor 210, the memory 220, the error correction circuit 230, the host interface 240, the memory interface 250, and the super block manager 260 of the controller 200 may communicate with each other through the communication bus 270.

In an embodiment, when a write request is received from the host 300 through the host interface 240, the processor 210 may determine whether a super block corresponding to the write request has been allocated. Depending on whether the super block has been allocated, the processor 210 may generate a command that instructs write data to be stored in one of the allocated super block and an additional super block.

In an embodiment, the super block manager 260 may determine a super block that is not used for a certain period based on the number of times the write request is received (i.e., write request count), and may deallocate the determined super block.

In accordance with the present disclosure, there are provided a storage device having improved lifespan and a method of operating the storage device.

While the present disclosure has been shown and described with reference to certain embodiments thereof, it will be understood by those skilled in the art that various changes in form and details may be made therein without departing from the scope of the present disclosure and any equivalents. Therefore, the scope of the present disclosure should not be limited to the above-described embodiments but should include the equivalents thereof.

In the above-described embodiments, all operations may be selectively performed, or part of the operations may be omitted. In each embodiment, the operations are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

The embodiments of the present disclosure have been described in the drawings and specification. Although specific terminologies are used here, those are only to describe the embodiments of the present disclosure. Therefore, the present disclosure is not restricted to the above-described embodiments and many variations are possible within the scope of the present disclosure. It should be apparent to those skilled in the art that various modifications can be made on the basis of the technological scope of the present disclosure in addition to the embodiments disclosed herein. Furthermore, the embodiments may be combined to form additional embodiments.

What is claimed is:

1. A storage device comprising:
a memory device including a plurality of super blocks, each including a plurality of memory blocks; and
a controller configured to control the memory device in response to each request among a plurality of requests from a host,
wherein the controller is further configured to:
allocate a first super block among the plurality of super blocks to a first write request among the plurality of requests from the host, and allocate a second super block among the plurality of super blocks to a second write request among the plurality of requests from the host, the second super block being different from the first super block, the first write request being a request of a first type, the second write request being a request of a second type different from the first type,
control the memory device to store in the first super block write data corresponding to the first write request,
deallocate at least one of the first super block and the second super block, and
when the second write request is received from the host before the second super block is reallocated after the deallocation of the second super block, control the memory device to store in the first super block write data corresponding to the second write request.

2. The memory device according to claim 1, wherein the first write request includes one of a sequential write request and a random write request.

3. The storage device according to claim 1, wherein the controller is further configured to reallocate the second super block in response to the second write request.

4. The storage device according to claim 1, wherein the controller is further configured to, when the second write request is received from the host after the second super block is reallocated, control the memory device to store in the second super block the write data corresponding to the second write request.

5. The storage device according to claim 1, wherein the controller is further configured to count, as a first count, a number of times the first write request is received from the host and count, as a second count, a number of times the second write request is received from the host.

6. The storage device according to claim 5, wherein the controller is further configured to determine at least one of the first super block and the second super block, which is not used for a particular period, based on the first count and the second count, and to deallocate the determined super block.

7. A storage device comprising:
a memory device including a plurality of super blocks, each including a plurality of memory blocks; and
a controller configured to control the memory device in response to each request among a plurality of requests from a host,
wherein the controller is further configured to:
allocate a first super block among the plurality of super blocks in response to a first write request among the plurality of requests from the host, the first write request being a request of a first type,
allocate a second super block among the plurality of super blocks in response to a second write request among the plurality of requests from the host, the second write request being a request of a second type different from the first type,
count, as a first count, a number of times the first write request is received from the host and count, as a second count, a number of times the second write request is received from the host, and
deallocate the first super block or the second super block based on the first count and the second count.

8. The storage device according to claim 7, wherein the controller is further configured to increase the first count when the first write request is received from the host, and increase the second count when the second write request is received from the host.

9. The storage device according to claim 7, wherein the controller is further configured to initialize the first count and the second count when one of the first count and the second count reaches a reference value.

10. The storage device according to claim 7, wherein the controller is further configured to deallocate the second super block when the first count reaches the reference value and the second count is zero (0), and
deallocate the first super block when the second count reaches the reference value and the first count is zero (0).

11. The storage device according to claim 7, wherein the controller is further configured to receive the first write request from the host and control the memory device to store write data corresponding to the first write request in one of the first super block and the second super block depending on whether the first super block has been allocated.

12. The storage device according to claim 11, wherein the controller is further configured to, when the first super block has been allocated, control the memory device to store in the first super block the write data corresponding to the first write request.

13. The storage device according to claim 11, wherein the controller is further configured to, when the first super block has not been allocated, control the memory device to store in the second super block the write data corresponding to the first write request.

14. A method of operating a storage device, the method comprising:
allocating storage regions to write requests of different types among requests from a host;
monitoring, as a first count, a number of times a write request of a first type among the writes requests is received from the host, and, as a second count, a number of times a write request of a second type is received from the host, the second type being different from the first type;
deallocating one of storage regions respectively corresponding to the write request of the first type and the write request of the second type, based on the first count and the second count;
receiving, from the host, the write request of the first type;
determining whether a deallocated storage region corresponds to the write request of the first type; and
storing write data corresponding to the received write request of the first type in one of the storage regions respectively corresponding to the write request of the first type and the write request of the second type based on a result of the determination.

15. The method according to claim 14, wherein the monitoring comprises:
when the write request of the first type is received, increasing the first count;
when the write request of the second type is received, increasing the second count; and
initializing the first count and the second count in response to a determination that one of the first count and the second count reaches a reference value.

16. The method according to claim 15, wherein the deallocating comprises:
deallocating the storage region corresponding to the write request of the first type in response to a determination that the second count reaches the reference value and the first count is zero (0),
wherein the determining comprises:
determining that the deallocated storage region corresponds to the write request of the first type,
wherein the storing the write data comprises:
storing the write data in the storage region corresponding to the write request of the second type.

17. The method according to claim 16, further comprising:
when the write data is stored in the storage region corresponding to the write request of the second type, reallocating the storage region corresponding to the write request of the first type; and
moving the write data stored in the storage region corresponding to the write request of the second type to the reallocated storage region corresponding to the write request of the first type,
wherein the moving is performed during a period in which the requests of the host are not received.

18. The method according to claim 15, wherein the deallocating comprises:
deallocating the storage region corresponding to the write request of the second type in response to a determination that the first count reaches the reference value and the second count is zero (0).

19. The method according to claim 18, wherein the determining comprises:
determining that the deallocated storage region does not correspond to the write request of the first type,
wherein the storing the write data comprises:
storing the write data in the storage region corresponding to the write request of the first type.

20. The method according to claim 14, further comprising:
before deallocating, receiving from the host, the write request of the first type and the write request of the second type; and
storing pieces of write data, respectively corresponding to the write request of the first type and the write request of the second type, in the storage regions respectively corresponding to the write request of the first type and the write request of the second type.
